(19) United States
(12) Patent Application Publication
(10) Pub. No.: US 2025/0226597 A1
(43) Pub. Date: Jul. 10, 2025

(54) CONNECTOR-ATTACHED WIRE HARNESS AND CONNECTOR

(71) Applicants: YAZAKI CORPORATION, Tokyo (JP); JATCO LTD, Shizuoka (JP); NISSAN MOTOR CO., LTD., Kanagawa (JP)

(72) Inventors: Masataka NAGAYAMA, Shizuoka (JP); Shinji OHTSUKA, Shizuoka (JP); Takeshi KATO, Shizuoka (JP); Tomoya OTAKI, Shizuoka (JP); Atsushi NOMA, Shizuoka (JP); Wataru MATSUSHIMA, Shizuoka (JP)

(73) Assignees: YAZAKI CORPORATION, Tokyo (JP); JATCO LTD, Shizuoka (JP); NISSAN MOTOR CO., LTD., Kanagawa (JP)

(21) Appl. No.: 19/081,447

(22) Filed: Mar. 17, 2025

Related U.S. Application Data
(63) Continuation of application No. PCT/JP2023/038607, filed on Oct. 25, 2023.

(30) Foreign Application Priority Data
Oct. 26, 2022 (JP) 2022-171795

(51) Int. Cl. H01R 4/34

(52) U.S. Cl. CPC H01R 4/34

(57) ABSTRACT

A connector-attached wire harness includes a connector that includes a housing, a plurality of plate-like terminals accommodated in the housing, and a plurality of nuts respectively sandwiched between tip end portions of the plurality of terminals and the housing, a plurality of plate-shaped counterpart terminals that are overlapped on and fastened to the tip end portions of the plurality of terminals by bolts, respectively, and a plurality of electric wires to which the plurality of counterpart terminals are respectively connected at ends thereof. The housing includes a bottom portion on which the plurality of nuts are mounted, a first wall portion standing from the bottom portion between the counterpart terminal and the counterpart terminal adjacent to each other, and a pair of second wall portions standing from the first wall portion in an arrangement direction of the counterpart terminals and respectively covering the adjacent counterpart terminals.

### CROSS-REFERENCE TO RELATED APPLICATIONS

This is a continuation of International Application No. PCT/JP2023/038607 filed on Oct. 25, 2023, and claims priority from Japanese Patent Application No. 2022-171795 filed on Oct. 26, 2022, the entire content of which is incorporated herein by reference.

### TECHNICAL FIELD

The present disclosure relates to a connector-attached wire harness and a connector.

### BACKGROUND ART

In the related art, when a connector used in a vehicle and electric wires are connected to each other, a plurality of bus bars (terminals) accommodated in a housing and a plurality of counterpart terminals connected to one ends of the electric wires are fastened by bolts as disclosed in JP2019-215995A.

The electric wire may be connected between the connector and another product in a bent state. Therefore, when the counterpart terminal is simply placed on the bus bar, a force of the electric wire returning straight causes the counterpart terminal come off the bus bar. In this case, after the other ends of the plurality of electric wires are first connected to another product, it is necessary to search for an electric wire to be connected to a predetermined bus bar from the plurality of electric wires, guide one end of the electric wire to the predetermined bus bar, and fasten the bus bar and a counterpart terminal connected to the one end of the electric wire with a bolt, which causes a problem of poor workability.

The present disclosure has been made in view of the above circumstances, and an object of the present disclosure is to provide a connector-attached wire harness and a connector in which a counterpart terminal connected to an electric wire is temporarily fixed to a housing to improve workability of bolt fastening between a terminal accommodated in the housing and the counterpart terminal.

### SUMMARY OF INVENTION

In order to achieve the above object, a connector-attached wire harness according to the present disclosure is characterized as follows.

A connector-attached wire harness including:
a connector that includes
   a housing,
   a plurality of plate-like terminals accommodated in the housing, and
   a plurality of nuts respectively sandwiched between tip end portions of the plurality of terminals and the housing;
a plurality of plate-shaped counterpart terminals that are overlapped on and fastened to the tip end portions of the plurality of terminals by bolts, respectively; and
a plurality of electric wires to which the plurality of counterpart terminals are respectively connected at ends of the plurality of electric wires, in which
the housing includes
   a bottom portion on which the plurality of nuts are mounted,
   a first wall portion standing from the bottom portion between the counterpart terminal and the counterpart terminal adjacent to each other, and
   a pair of second wall portions standing from the first wall portion in an arrangement direction of the counterpart terminals and respectively covering the adjacent counterpart terminals.

In order to achieve the above object, a connector according to the present disclosure is characterized as follows.

A connector including:
a housing;
a plurality of plate-like terminals accommodated in the housing; and
a plurality of nuts respectively sandwiched between tip end portions of the plurality of terminals and the housing, in which
a plate-shaped counterpart terminal is overlapped on and fastened to the tip end portion of the terminal by a bolt to connect the counterpart terminal and the terminal, and
the housing includes
   a bottom portion on which the plurality of nuts are mounted,
   a first wall portion standing from the bottom portion between the counterpart terminal and the counterpart terminal adjacent to each other, and
   a pair of second wall portions standing from the first wall portion in an arrangement direction of the counterpart terminals and respectively covering the adjacent counterpart terminals.

### ADVANTAGEOUS EFFECTS OF INVENTION

According to the present disclosure, it is possible to provide a connector-attached wire harness and a connector in which a counterpart terminal connected to an electric wire can be temporarily fixed to a housing and workability of bolt fastening between a terminal accommodated in the housing and the counterpart terminal is improved.

The present disclosure has been briefly described above. Details of the present disclosure can be clarified by reading modes (hereinafter, referred to as “embodiments”) for carrying out the disclosure to be described below with reference to the accompanying drawings.

### BRIEF DESCRIPTION OF DRAWINGS

FIG. 1 is a perspective view of a connector according to an embodiment of the present disclosure.

FIG. 2 is an exploded perspective view of a connector-attached wire harness including the connector shown in FIG. 1.

FIG. 3 is a perspective view of a housing shown in FIG. 2.

FIG. 4 is a partial perspective view of the connector-attached wire harness shown in FIG. 2.

FIG. 5 is a partial rear view of the connector-attached wire harness shown in FIG. 4.

FIG. 6 is a partial right side view of the connector shown in FIG. 1.

FIG. 7 is a partial left side view of the connector shown in FIG. 1.

FIG. 8 is a partial bottom view of the connector shown in FIG. 1.

### DESCRIPTION OF EMBODIMENTS

A specific embodiment of the present disclosure will be described below with reference to the drawings.

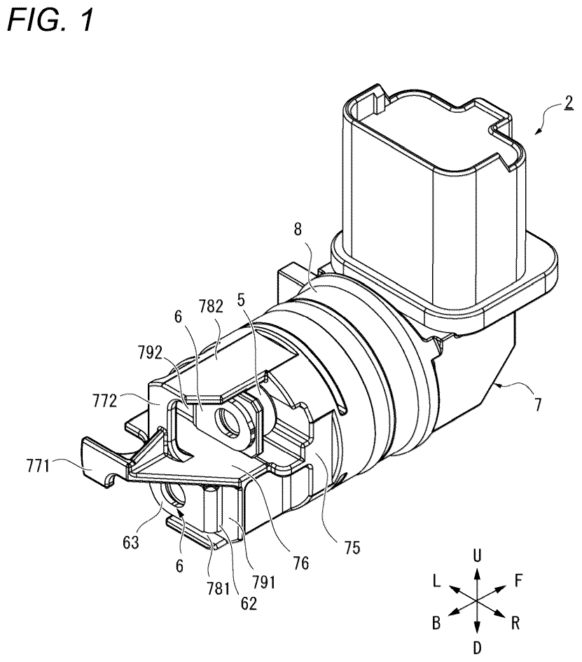

Hereinafter, for convenience of description, “front (F)”, “rear (B)”, “left (L)”, “right (R)”, “up (U)”, and “down (D)” are defined as shown in FIGS. 1 to 8. A “front-rear direction”, a “left-right direction”, and an “up-down direction” are orthogonal to one another. The up-down direction corresponds to an “arrangement direction” in the present disclosure. A left side in the left-right direction corresponds to a “leading-out direction” of the present disclosure. A rear side in the front-rear direction corresponds to a “standing direction” of the present disclosure.

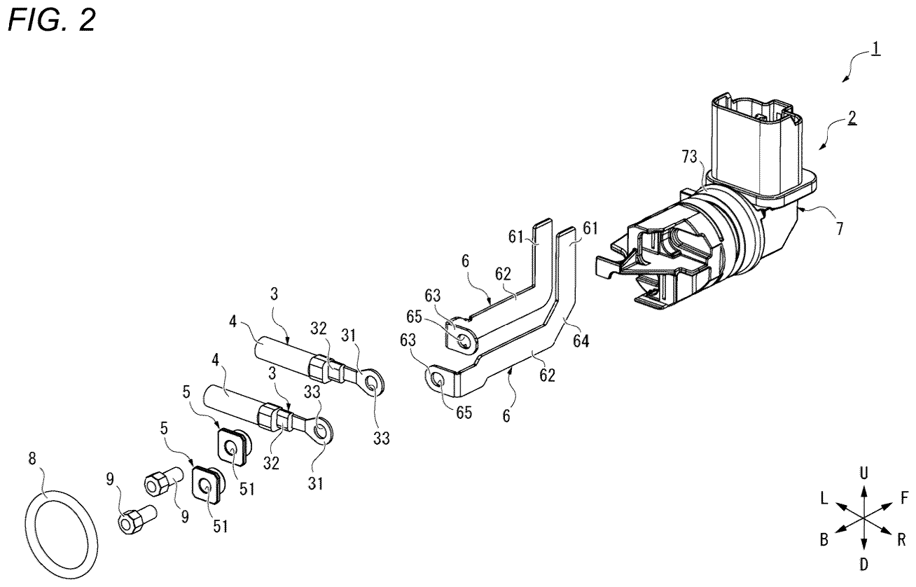

As shown in FIGS. 1 and 2, a connector-attached wire harness 1 includes a connector 2, LA terminals 3 (see FIG. 2) as counterpart terminals connected to the connector 2, and electric wires 4 (see FIG. 2) to which the LA terminals 3 are attached. The connector 2 is attached to a device case or the like. In the connector 2, a front side of an O-ring groove 73 (see FIG. 2) to which an O-ring 8 to be described later is attached is disposed in an air environment outside the device case, and a rear side of the O-ring 8 is disposed in an oil environment inside the device case. The LA terminals 3 and the electric wires 4 are accommodated in the device case.

As shown in FIG. 2, the connector 2 includes a pair of nuts 5, 5, a pair of male terminals 6, 6 as terminals, a housing 7, and the O-ring 8. The nut 5 is a known nut having a screw hole 51 that penetrates in the front-rear direction and into which a bolt 9 is screwed.

The male terminal 6 is formed by cutting out and bending a metal plate. In the present embodiment, the pair of male terminals 6 are provided side by side in the left-right direction. The pair of male terminals 6, 6 are accommodated in the housing 7 such that a plate thickness direction is along the left-right direction.

The male terminal 6 on a left side includes a first connection portion 61 extending along the up-down direction and connected to a mating connector (not shown) disposed outside the device case, a first portion 62 extending from a lower end of the first connection portion 61 toward the rear side, and a second connection portion 63 as a tip end portion bent from a rear end of the first portion 62 toward an inner side in the left-right direction (a right side).

The male terminal 6 on a right side includes the first connection portion 61 extending along the up-down direction and connected to the mating connector (not shown) disposed outside the device case, a second portion 64 extending obliquely rearward and downward from a lower end of the first connection portion 61, the first portion 62 extending rearward from a lower end of the second portion 64, and the second connection portion 63 bent from a rear end of the first portion 62 toward an inner side in the left-right direction (a left side).

The lengths of the first connection portions 61 of the pair of male terminals 6, 6 in the up-down direction are the same. The lengths of the first portions 62 of the pair of male terminals 6, 6 in the front-rear direction are also the same. By providing the second portion 64 only in the male terminal 6 on the right side, the first portion 62 of the male terminal 6 on the right side is disposed below the first portion 62 of the male terminal 6 on the left side. In addition, the second connection portion 63 of the male terminal 6 on the right side is disposed on a rear side and a lower side of the second connection portion 63 of the male terminal 6 on the left side. That is, the second connection portions 63 of the pair of male terminals 6 are arranged side by side in the front-rear direction and the up-down direction. The second connection portion 63 is provided with a bolt through hole 65 through which the bolt 9 passes.

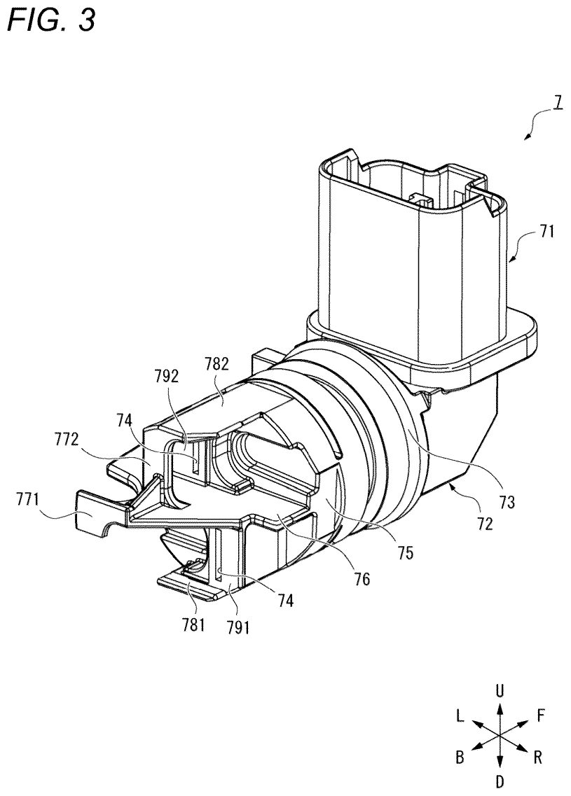

The housing 7 is made of resin. As shown in FIG. 3, the housing 7 has an in-air 5 portion 71 along the up-down direction and an in-oil portion 72 provided to extend rearward from a lower end of the in-air portion 71. The first connection portion 61 and the second portion 64 of the male terminal 6 are accommodated in the in-air portion 71. The in-air portion 71 is provided in a bottomed tubular shape opened upward, and by injecting a filler into a bottom portion thereof, water-tightness between the in-air portion 71 and the in-oil portion 72 is ensured in the housing 7.

The in-oil portion 72 is provided with the O-ring groove 73 for accommodating the O-ring 8 on the outer surface on the front side. The in-oil portion 72 is provided with accommodation holes 74 for accommodating the first portions 62 of the male terminals 6. As shown in FIGS. 1, 3, and 5, the in-oil portion 72 further includes a rear end portion 75 as a bottom portion, a first wall portion 76, a pair of second wall portions 771, 772, a pair of third wall portions 781, 782, and a pair of fourth wall portions 791, 792.

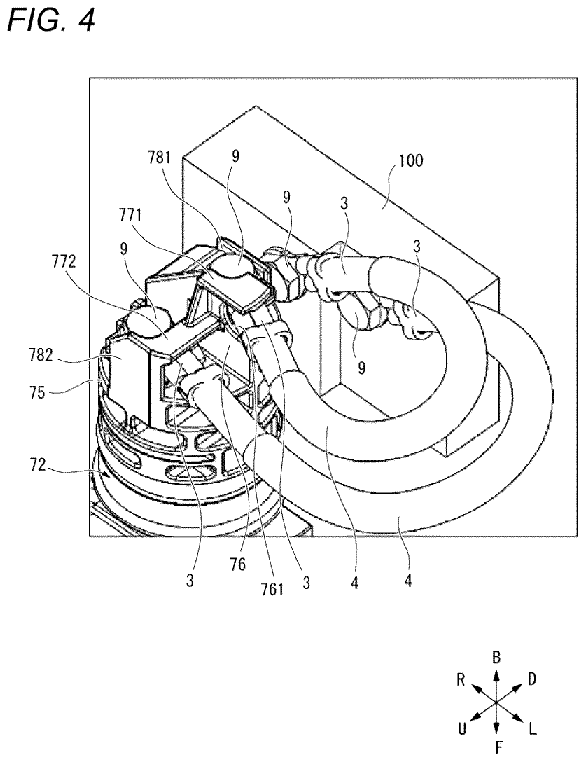

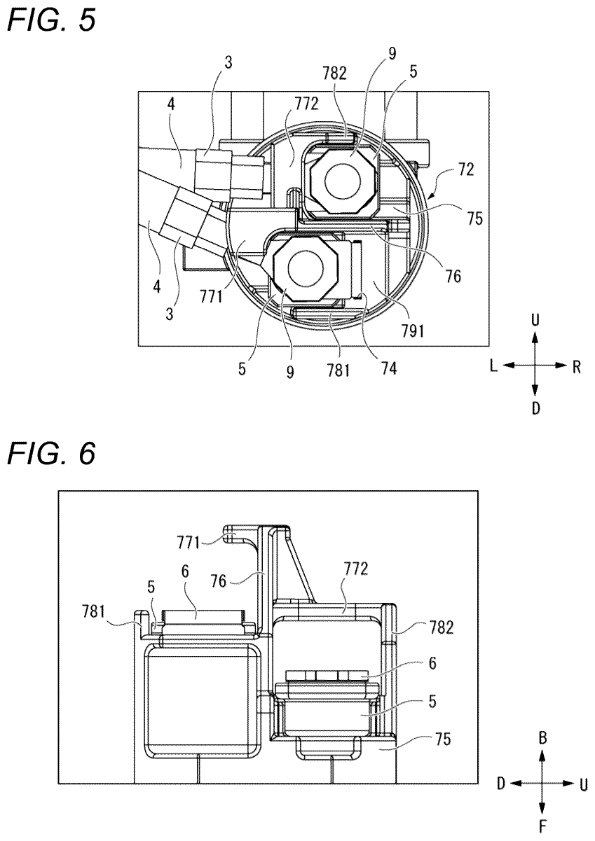

As shown in FIG. 1, the pair of nuts 5, 5 are mounted on the rear end portion 75. The first wall portion 76 stands rearward from the rear end portion 75 and extends in the left-right direction. As shown in FIGS. 4 and 5, the first wall portion 76 is disposed between the LA terminal 3 and the LA terminal 3 adjacent to each other in the up-down direction, and insulates the two LA terminals 3, 3 from each other. The second wall portion 771 stands downward and upward from the first wall portion 76 and covers the LA terminal 3 on a lower side. The second wall portion 772 stands upward from the first wall portion 76 and covers the LA terminal 3 on an upper side.

The third wall portion 781 stands rearward from the rear end portion 75 and accommodates the nut 5 disposed below the first wall portion 76 between the third wall portion 781 and the first wall portion 76. The third wall portion 782 stands rearward from the rear end portion 75 and accommodates the nut 5 disposed above the first wall portion 76 between the third wall portion 782 and the first wall portion 76.

As shown in FIG. 3, the fourth wall portion 791 stands rearward from the rear end portion 75 and is provided to connect the third wall portion 781 on the lower side and the first wall portion 76. The fourth wall portion 792 stands rearward from the rear end portion 75 and is provided to connect the third wall portion 782 on the upper side and the first wall portion 76. The fourth wall portion 792 is provided on the left side of the fourth wall portion 791. The accommodation hole 74 that accommodates the male terminal 6 on the left side is provided to communicate with the fourth wall portion 792 on the left side. The accommodation hole 74 that accommodates the male terminal 6 on the right side is provided to communicate with the fourth wall portion 791 on the right side.

The rear end portion 75, the first wall portion 76 at a center, the fourth wall portion 792 on the left side, and the third wall portion 782 on the upper side of the in-oil portion 72 described above are provided with a nut accommodation groove for accommodating the nut 5 connected to the male terminal 6 on the left side. The nut accommodation groove extends in the left-right direction, and an insertion port for inserting the nut 5 is provided on the right side thereof.

The rear end portion 75, the first wall portion 76 at the center, the fourth wall portion 791 on the right side, and the third wall portion 781 on the lower side of the in-oil portion 72 described above are provided with a nut accommodation groove for accommodating the nut 5 connected to the male terminal 6 on the right side. The nut accommodation groove extends in the left-right direction, and an insertion port for inserting the nut 5 is provided on the left side thereof.

As shown in FIG. 1, the rear end of the first portion 62 and the second connection portion 63 of the male terminal 6 protrude from the accommodation hole 74 to the outside of the housing 7. The second connection portion 63 is bent from the rear end of the first portion 62 toward the insertion port of the nut accommodation groove. The second connection portion 63 is spaced apart from the rear end portion 75 in the front-rear direction. When the nut 5 is accommodated between the second connection portion 63 and the rear end portion 75, the nut 5 is sandwiched between the second connection portion 63 and the housing 7.

As shown in FIG. 2, in the LA terminal 3, a terminal connection portion 31 connected to the male terminal 6 and an electric wire connection portion 32 connected to the electric wire 4 are provided continuously in the left-right direction. The terminal connection portion 31 is provided in a plate shape, and is provided with a bolt through hole 33 through which the bolt 9 penetrating in the front-rear direction passes. In the present embodiment, as shown in FIGS. 4 and 5, the LA terminals 3 are fastened to the male terminals 6 of the connector 2 by bolts such that the leading-out directions of the two electric wires 4 are on the left side.

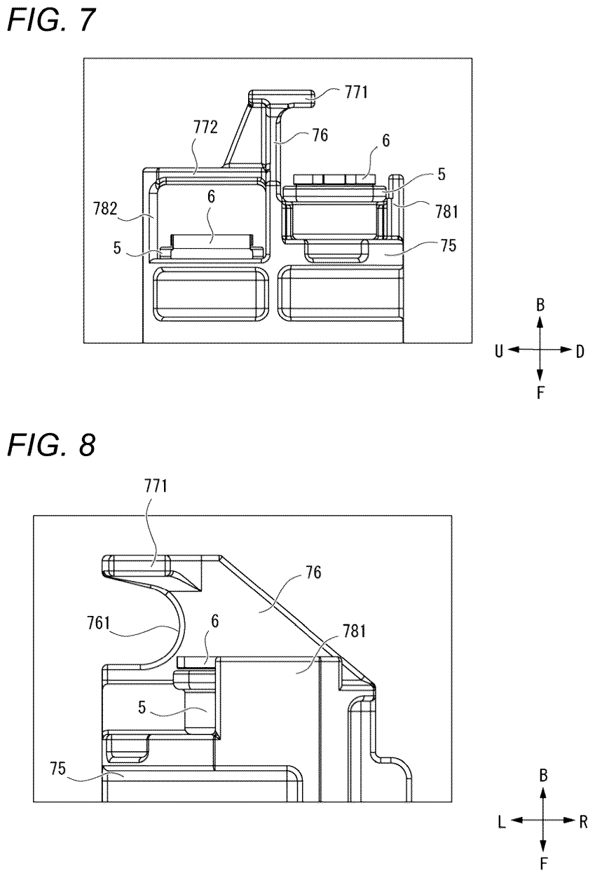

Next, a more detailed configuration of the housing 7 described above will be described. As shown in FIGS. 6 and 7, at the rear end portion 75, the lower side of the first wall portion 76 is provided to further protrude rearward than the upper side of the first wall portion 76. Further, the second wall portion 771 standing downward from the first wall portion 76 is provided behind the second wall portion 772 standing upward from the first wall portion 76.

As shown in FIGS. 4 and 5, the second wall portion 771 described above stands upward and downward from the first wall portion 76 and covers the LA terminal 3 on the lower side. The second wall portion 771 is provided so as to stand from the left end of the first wall portion 76, and is provided so as to cover the electric wire 4 side beyond a portion of the LA terminal 3 on the lower side on which the bolt 9 is overlapped. Accordingly, the second wall portion 771 does not interfere with a bolt fastening work. In addition, a lower end of the second wall portion 771 is not connected to the third wall portion 781 and the second wall portion 771 is provided away from the third wall portion 781.

The second wall portion 772 described above stands upward from the first wall portion 76 and covers the LA terminal 3 on the upper side. An upper end of the second wall portion 772 is connected to a left end of the third wall portion 782. The second wall portion 772 is also provided so as to cover the electric wire 4 side beyond a portion of the LA terminal 3 on the upper side on which the bolt 9 is overlapped. Accordingly, the second wall portion 772 does not interfere with the bolt fastening work. As shown in FIG. 8, the first wall portion 76 has a notch 761 at a left end thereof. The notch 761 is provided between a lower side of the first wall portion 76 and the second wall portion 771 at the rear end portion 75.

Next, as shown in FIG. 4, a procedure of connecting the connector 2 disposed on the upper side and the other product 100 disposed on the lower side by the electric wire 4 will be described. As shown in FIG. 4, the LA terminals 3 are connected to both ends of the electric wire 4. The LA terminal 3 connected to one end of the electric wire 4 is fastened to the male terminal 6 of the connector 2 by a bolt, and the LA terminal 3 connected to the other end of the electric wire 4 is fastened to the other product 100 by a bolt. The electric wire 4 connected to the male terminal 6 on the lower side is bent more than the electric wire 4 connected to the male terminal 6 on the upper side.

First, the LA terminal 3 is overlapped with the male terminal 6 on the lower side of the connector 2 from between the second wall portion 771 and the third wall portion 781 with the electric wire 4 facing leftward. Next, the LA terminal 3 connected to the other end of the electric wire 4 is bent toward the right side, and is overlapped on a side surface of the other product 100 perpendicular to the up-down direction and fastened by a bolt. The LA terminal 3 on the other product 100 side is fastened to the front side of the LA terminal 3 on the connector 2 side. Therefore, due to a force of the electric wire 4 tending to extend straight, the LA terminal 3 on the connector 2 side is directed upward and rearward, but is held down by the first wall portion 76 and the second wall portion 771, and the LA terminal 3 can be temporarily fixed to the connector 2.

The LA terminal 3 is passed through the rear end portion 75 side of the second wall portion 772 and overlapped with the male terminal 6 on the upper side of the connector 2 with the electric wire 4 facing leftward. Next, the LA terminal 3 connected to the other end of the electric wire 4 is bent toward the right side, and is overlapped on the side surface of the other product 100 and fastened by a bolt. The LA terminal 3 on the other product 100 side is fastened to the front side of the LA terminal 3 on the connector 2 side by a bolt. Therefore, due to a force of the electric wire 4 tending to extend straight, the LA terminal 3 on the connector 2 side is directed upward and rearward, but is pressed by the third wall portion 782 and the second wall portion 772, and the LA terminal 3 can be temporarily fixed to the connector 2. Therefore, after the LA terminals 3 are fastened to the other product 100 by bolts, the temporarily fixed LA terminals 3 only needs to be fastened by bolts without searching for the electric wires 4 to be connected to the male terminals 6 on the upper and lower sides of the two electric wires 4, and thus the fastening workability can be improved.

According to the embodiment described above, the housing 7 includes the pair of second wall portions 771, 772 that respectively stand in the up-down direction from the first wall portion 76 and respectively cover the adjacent LA terminals 3. As a result, even when the electric wires 4 are bent and the LA terminals 3 move in a direction (rearward) away from the rear end portion 75, the LA terminals 3 can be pressed by the second wall portions 771, 772, and temporarily fixed to the housing 7, and workability of bolt fastening of the male terminals 6 and the LA terminals 3 can be improved. Further, the second wall portions 771, 772 serve as partition walls between the adjacent LA terminals 3, 3, and an insulation distance can be increased.

According to the embodiment described above, the lower end of the second wall portion 771 is provided away from the third wall portion 781. Accordingly, the electric wire 4 can be disposed on the male terminal 6 from between a tip end of the second wall portion 771 and the third wall portion 781 without passing through the second wall portion 771 to the rear end portion 75 side, and handleability is improved.

According to the embodiment described above, the upper end of the second wall portion 772 is connected to the third wall portion 782. Accordingly, it is possible to further prevent the LA terminal 3 connected to the electric wire 4 from coming off from the temporary fixation.

According to the embodiment described above, the first wall portion 76 is provided with the notch 761 at the end portion in the leading-out direction of the electric wire 4. Accordingly, as shown in FIG. 4, the electric wire 4 can be inserted into the notch 761, and a bending radius of the electric wire 4 can be increased.

According to the embodiment described above, at the rear end portion 75, the lower side of the first wall portion 76 is provided to further protrude rearward than the upper side of the first wall portion 76, and the notch 761 is provided between the lower side of the first wall portion and the second wall portion 771 at the rear end portion 75. Accordingly, since the positions of the adjacent LA terminals 3 in the front-rear direction are different, even when the LA terminal 3 on the lower side is inserted into the notch 761, insulation of the adjacent LA terminals 3 can be ensured.

According to the embodiment described above, the second wall portion 771 stands on both sides in the up-down direction from the first wall portion 76. Accordingly, it is possible to prevent the LA terminal 3 inserted into the notch 761 from coming off from the temporary fixation.

The present disclosure is not limited to the embodiment described above, and can be appropriately modified, improved, or the like. In addition, materials, shapes, sizes, numbers, arrangement positions and the like of components in the above embodiment are freely selected and are not limited as long as the present disclosure can be implemented.

According to the embodiment described above, the tip end of the second wall portion 771 is provided away from the third wall portion 781, but the present disclosure is not limited thereto. The tip end of the second wall portion 771 may be connected to the third wall portion 781.

According to the embodiment described above, the second wall portion 772 is connected to the third wall portion 782, but the present disclosure is not limited thereto. The second wall portion 772 may be provided away from the third wall portion 782.

It is not essential to provide the notch 761 in the first wall portion 76, and the notch 761 may be omitted.

According to the embodiment described above, at the rear end portion 75, the lower side of the first wall portion 76 further protrudes rearward than the upper side of the first wall portion 76, but the present disclosure is not limited thereto. The rear end portion 75 may be flat.

Here, the characteristics of the embodiment of the connector-attached wire harness and the connector according to the present disclosure described above are briefly summarized and listed in the following (i) to (vii).
(i)

A connector-attached wire harness (1) including:
a connector (2) that includes
   a housing (7),
   a plurality of plate-like terminals (6) accommodated in the housing (7), and
   a plurality of nuts (5) respectively sandwiched between tip end portions (63) of the plurality of terminals (6) and the housing (7);
a plurality of plate-shaped counterpart terminals (3) that are overlapped on and fastened to the tip end portions (63) of the plurality of terminals (6) by bolts, respectively; and
a plurality of electric wires (4) to which the plurality of counterpart terminals (3) are respectively connected at ends of the plurality of electric wires (4),
wherein the housing (7) includes
   a bottom portion (75) on which the plurality of nuts (5) are mounted,
   a first wall portion (76) standing from the bottom portion (75) between the counterpart terminal (3) and the counterpart terminal (3) adjacent to each other, and
   a pair of second wall portions (771, 772) standing from the first wall portion (76) in an arrangement direction (up-down direction) of the counterpart terminals (3) and respectively covering the adjacent counterpart terminals (3).

With the above configuration (i), even when the electric wire (4) is bent and the counterpart terminal (3) moves in a direction (rearward) away from the bottom portion (75), the counterpart terminal (3) can be pressed by the second wall portion (771, 772) and temporarily fixed to the housing (7), and the workability of bolt fastening of the terminal (6) and the counterpart terminal (3) can be improved. Further, the second wall portion (771, 772) serves as a partition wall between the adjacent LA terminals (3, 3), and an insulation distance can be increased.
(ii)

The connector-attached wire harness (1) according to (i),
wherein the housing (7) includes a pair of third wall portions (781, 782) standing from the bottom portion (75) and respectively accommodating the nuts (5) disposed on both sides of the first wall portion (76) in the arrangement direction (up-down direction) between the third wall portions and the first wall portion (76), and
wherein a tip end of the second wall portion (771) covering the counterpart terminal (3) on one side in the arrangement direction (up-down direction) is provided away from the third wall portion (781) on the one side in the arrangement direction (up-down direction).

With the above configuration (ii), the electric wire (4) can be disposed on the terminal (6) from between the tip end of the second wall portion (771) and the third wall portion (781) without passing through the second wall portion (771) to the bottom portion (75) side, and handleability is improved.
(iii)

The connector-attached wire harness (1) according to (ii),
wherein a tip end of the second wall portion (772) covering the counterpart terminal (3) on another side in the arrangement direction (up-down direction) is connected to the third wall portion (782) on the other side in the arrangement direction (up-down direction).

With the above configuration (iii), it is possible to further prevent the counterpart terminal (3) from coming off from the temporary fixation.
(iv)

The connector-attached wire harness (1) according to (i),
wherein the housing (7) includes a pair of third wall portions (781, 782) standing from the bottom portion (75) and respectively accommodating the nuts (5) disposed on both sides of the first wall portion (76) in the arrangement direction (up-down direction) between the third wall portions and the first wall portion (76), and
wherein a tip end of the second wall portion (772) covering the counterpart terminal (3) on one side in the arrangement direction (up-down direction) is connected to the third wall portion (782) on the one side in the arrangement direction (up-down direction).

With the above configuration (iv), it is possible to further prevent the counterpart terminal (3) from coming off from the temporary fixation.
(v)

The connector-attached wire harness (1) according to any one of (i) to (iv),
wherein the first wall portion (76) is provided with a notch (761) at an end portion on a side in a leading-out direction (left side) of the electric wire (4).

With the above configuration (v), the electric wire (4) can be inserted into the notch (761), and a bending radius of the electric wire (4) can be increased.
(vi)
The connector-attached wire harness (1) according to (v),
wherein at the bottom portion (75), the one side in the arrangement direction (up-down direction) of the first wall portion (76) protrudes further in a standing direction (rear side) of the first wall portion (76) than the other side in the arrangement direction (up-down direction) of the first wall portion (76), and
wherein the notch (761) is provided between the one side in the arrangement direction (up-down direction) of the first wall portion (76) and the second wall portion (771) covering the counterpart terminal (3) on the one side in the arrangement direction (up-down direction) at the bottom portion (75).

With the above configuration (vi), since the positions of the adjacent counterpart terminals (3) in a protruding direction can be made different from each other, insulation between the adjacent counterpart terminals (3) can be ensured even when the counterpart terminal (3) is inserted into the notch 761.
(vii)

The connector-attached wire harness (1) according to (vi),
the second wall portion (771) covering the counterpart terminal (3) on the one side in the arrangement direction (up-down direction) stands on both sides in the arrangement direction (up-down direction) from the first wall portion (76).

With the above configuration (vii), it is possible to prevent the LA terminal (3) inserted into the notch (761) from coming off from the temporary fixation.
[8]

A connector (2) including:
a housing (7);
a plurality of plate-like terminals (6) accommodated in the housing (7); and
a plurality of nuts (5) respectively sandwiched between tip end portions (63) of the plurality of terminals (6) and the housing (7),
wherein a plate-shaped counterpart terminal (3) is overlapped on and fastened to the tip end portion (63) of the terminal (6) by a bolt to connect the counterpart terminal (3) and the terminal (6), and
wherein the housing (7) includes
   a bottom portion (75) on which the plurality of nuts (5) are mounted,
   a first wall portion (76) standing from the bottom portion (75) between the counterpart terminal (3) and the counterpart terminal (3) adjacent to each other, and
   a pair of second wall portions (771, 772) standing from the first wall portion (76) in an arrangement direction (up-down direction) of the counterpart terminals (3) and respectively covering the adjacent counterpart terminals (3).

With the above configuration [8], even when the electric wire (4) is bent and the counterpart terminal (3) moves in a direction (rearward) away from the bottom portion (75), the counterpart terminal (3) can be pressed by the second wall portion (771, 772) and temporarily fixed to the housing (7), and the workability of bolt fastening of the terminal (6) and the counterpart terminal (3) can be improved. Further, the second wall portion (771, 772) serves as a partition wall between the adjacent LA terminals (3, 3), and the insulation distance can be increased.

### INDUSTRIAL APPLICABILITY

According to the present disclosure, it is possible to provide a connector-attached wire harness and a connector in which a counterpart terminal connected to an electric wire can be temporarily fixed to a housing and workability of bolt fastening between a terminal accommodated in the housing and the counterpart terminal is improved. The present disclosure exhibiting this effect is useful for a connector-attached wire harness and a connector.

What is claimed is:

1. A connector-attached wire harness comprising:
a connector that includes
a housing,
a plurality of plate-like terminals accommodated in the housing, and
a plurality of nuts respectively sandwiched between tip end portions of the plurality of terminals and the housing;
a plurality of plate-shaped counterpart terminals that are overlapped on and fastened to the tip end portions of the plurality of terminals by bolts, respectively; and
a plurality of electric wires to which the plurality of counterpart terminals are respectively connected at ends of the plurality of electric wires,
wherein the housing includes
a bottom portion on which the plurality of nuts are mounted,
a first wall portion standing from the bottom portion between the counterpart terminal and the counterpart terminal adjacent to each other, and
a pair of second wall portions standing from the first wall portion in an arrangement direction of the counterpart terminals and respectively covering the adjacent counterpart terminals,
wherein the housing includes a pair of third wall portions standing from the bottom portion and respectively accommodating the nuts disposed on both sides of the first wall portion in the arrangement direction between the third wall portions and the first wall portion, and
wherein a tip end of the second wall portion covering the counterpart terminal on one side in the arrangement direction is provided away from the third wall portion on the one side in the arrangement direction.

2. The connector-attached wire harness according to claim 1,
wherein a tip end of the second wall portion covering the counterpart terminal on another side in the arrangement direction is connected to the third wall portion on the other side in the arrangement direction.

3. The connector-attached wire harness according to claim 1,
wherein the housing includes a pair of third wall portions standing from the bottom portion and respectively accommodating the nuts disposed on both sides of the first wall portion in the arrangement direction between the third wall portions and the first wall portion, and
wherein a tip end of the second wall portion covering the counterpart terminal on one side in the arrangement direction is connected to the third wall portion on the one side in the arrangement direction.

4. A connector-attached wire harness comprising:
a connector that includes
a housing,
a plurality of plate-like terminals accommodated in the housing, and
a plurality of nuts respectively sandwiched between tip end portions of the plurality of terminals and the housing;
a plurality of plate-shaped counterpart terminals that are overlapped on and fastened to the tip end portions of the plurality of terminals by bolts, respectively; and
a plurality of electric wires to which the plurality of counterpart terminals are respectively connected at ends of the plurality of electric wires,
wherein the housing includes
a bottom portion on which the plurality of nuts are mounted,
a first wall portion standing from the bottom portion between the counterpart terminal and the counterpart terminal adjacent to each other, and
a pair of second wall portions standing from the first wall portion in an arrangement direction of the counterpart terminals and respectively covering the adjacent counterpart terminals, and
wherein the first wall portion is provided with a notch at an end portion on a side in a leading-out direction of the electric wire.

5. The connector-attached wire harness according to claim 4,
wherein at the bottom portion, the one side in the arrangement direction of the first wall portion protrudes further in a standing direction of the first wall portion than the other side in the arrangement direction of the first wall portion, and
wherein the notch is provided between the one side in the arrangement direction of the first wall portion and the second wall portion covering the counterpart terminal on the one side in the arrangement direction at the bottom portion.

6. The connector-attached wire harness according to claim 5,
the second wall portion covering the counterpart terminal on the one side in the arrangement direction stands on both sides in the arrangement direction from the first wall portion.

7. A connector comprising:
a housing;
a plurality of plate-like terminals accommodated in the housing; and
a plurality of nuts respectively sandwiched between tip end portions of the plurality of terminals and the housing,
wherein a plate-shaped counterpart terminal is overlapped on and fastened to the tip end portion of the terminal by a bolt to connect the counterpart terminal and the terminal, and
wherein the housing includes
a bottom portion on which the plurality of nuts are mounted,
a first wall portion standing from the bottom portion between the counterpart terminal and the counterpart terminal adjacent to each other, and
a pair of second wall portions standing from the first wall portion in an arrangement direction of the counterpart terminals and respectively covering the adjacent counterpart terminals,
wherein the housing includes a pair of third wall portions standing from the bottom portion and respectively accommodating the nuts disposed on both sides of the first wall portion in the arrangement direction between the third wall portions and the first wall portion, and
wherein a tip end of the second wall portion covering the counterpart terminal on one side in the arrangement direction is provided away from the third wall portion on the one side in the arrangement direction.

8. A connector comprising:
a housing;
a plurality of plate-like terminals accommodated in the housing; and
a plurality of nuts respectively sandwiched between tip end portions of the plurality of terminals and the housing,
wherein a plate-shaped counterpart terminal is overlapped on and fastened to the tip end portion of the terminal by a bolt to connect the counterpart terminal and the terminal, and
wherein the housing includes
a bottom portion on which the plurality of nuts are mounted,
a first wall portion standing from the bottom portion between the counterpart terminal and the counterpart terminal adjacent to each other, and
a pair of second wall portions standing from the first wall portion in an arrangement direction of the counterpart terminals and respectively covering the adjacent counterpart terminals, and
wherein the first wall portion is provided with a notch at an end portion on a side in a leading-out direction of the electric wire.
